(19) United States
(12) Patent Application Publication
(10) Pub. No.: US 2026/0295945 A1
(43) Pub. Date: Oct. 1, 2026

(54) METHOD FOR PRODUCING THREE-DIMENSIONAL OBJECT

(71) Applicant: SEIKO EPSON CORPORATION, Tokyo (JP)

(72) Inventor: Wataru ENDO, SHIOJIRI-SHI (JP)

(21) Appl. No.: 19/576,181

(22) Filed: Mar. 24, 2026

(30) Foreign Application Priority Data
Mar. 25, 2025 (JP) 2025-049490

(51) Int. Cl. B29C 64/386; B22F 10/22; B22F 10/80; B28B 1/00; B28B 17/00; B29C 64/118; B33Y 50/00

(52) U.S. Cl. CPC B29C 64/386; B22F 10/22; B22F 10/80; B28B 1/001; B28B 17/0081; B29C 64/118; B33Y 50/00

(57) ABSTRACT

To provide a method for producing a three-dimensional object for modeling the three-dimensional object by depositing a modeling material from a nozzle on a stage, and the method includes: a path information acquisition step of acquiring path information including a movement path along which the nozzle moves with respect to the stage while discharging the modeling material toward the stage; a speed determination step of determining a speed of the nozzle with respect to the stage based on a bending angle of the movement path in the path information and a distance for the speed of the nozzle with respect to the stage to reach a predetermined value; and a modeling step of depositing a modeling layer by discharging the modeling material from the nozzle while moving the nozzle with respect to the stage based on the path information and the determined speed of the nozzle.

The present application is based on, and claims priority from JP Application Serial Number 2025-049490, filed March 25, 2025, the disclosure of which is hereby incorporated by reference herein in its entirety.

### BACKGROUND

### 1. Technical Field

The present disclosure relates to a method for producing a three-dimensional object.

### 2. Related Art

There is a method for producing a three-dimensional object by discharging a plasticized material from nozzles toward a stage and curing the material.

For example, JP-A-2023-121204 describes a method for producing a three-dimensional object including a first process of determining a moving speed of a discharging unit in each of a plurality of partial paths based on an arrangement of endpoints representing a start point and an end point of the plurality of partial paths, the arrangement of the endpoints being in path information in which a movement path in which the discharging unit moves while discharging a modeling material toward a stage is indicated by the plurality of partial paths; and a second process of discharging the modeling material from the discharging unit while moving the discharging unit at the determined moving speed to deposit layers.

JP-A-2023-121204 is an example of the related art.

In the method for producing a three-dimensional object as described above, it is desired to achieve both productivity and accuracy of the three-dimensional object.

### SUMMARY

A method for producing a three-dimensional object according to an aspect of the present disclosure is a method for producing a three-dimensional object for modeling the three-dimensional object by depositing a modeling material from a nozzle on a stage, and the method includes: a path information acquisition step of acquiring path information including a movement path along which the nozzle moves with respect to the stage while discharging the modeling material toward the stage; a speed determination step of determining a speed of the nozzle with respect to the stage based on a bending angle of the movement path in the path information and a distance for the speed of the nozzle with respect to the stage to reach a predetermined value; and a modeling step of depositing a modeling layer by discharging the modeling material from the nozzle while moving the nozzle with respect to the stage based on the path information and the determined speed of the nozzle.

### BRIEF DESCRIPTION OF THE DRAWINGS

FIG. 1 is a cross-sectional view schematically illustrating a three-dimensional modeling apparatus according to the embodiment.

FIG. 2 is a perspective view schematically illustrating a flat screw of the three-dimensional modeling apparatus according to the embodiment.

FIG. 3 is a plan view schematically illustrating a barrel of the three-dimensional modeling apparatus according to the embodiment.

FIG. 4 is a flowchart illustrating processing of a control unit of the three-dimensional modeling apparatus according to the embodiment.

FIG. 5 is a cross-sectional view illustrating modeling processing performed by the control unit of the three-dimensional modeling apparatus according to the embodiment.

FIG. 6 is a table illustrating data used in processing of the control unit of the three-dimensional modeling apparatus according to the embodiment.

FIG. 7 is a flowchart illustrating processing of the control unit of the three-dimensional modeling apparatus according to the embodiment.

FIG. 8 is a flowchart illustrating processing of the control unit of the three-dimensional modeling apparatus according to the embodiment.

FIG. 9 is a flowchart illustrating processing of the control unit of the three-dimensional modeling apparatus according to the embodiment.

FIG. 10 is a flowchart illustrating processing of the control unit of the three-dimensional modeling apparatus according to the embodiment.

FIG. 11 is a diagram illustrating a movement path of a nozzle of the three-dimensional modeling apparatus according to the embodiment with respect to a stage.

FIG. 12 is a diagram illustrating a movement path of the nozzle of the three-dimensional modeling apparatus according to the embodiment with respect to the stage.

FIG. 13 is a diagram illustrating a movement path of the nozzle of the three-dimensional modeling apparatus according to the embodiment with respect to the stage.

FIG. 14 is a flowchart illustrating a modification of the processing of the control unit of the three-dimensional modeling apparatus according to the embodiment.

FIG. 15 is a flowchart illustrating a modification of the processing of the control unit of the three-dimensional modeling apparatus according to the embodiment.

FIG. 16 is a diagram illustrating a movement path of the nozzle of the three-dimensional modeling apparatus according to the embodiment with respect to the stage.

FIG. 17 is a diagram illustrating a movement path of the nozzle of the three-dimensional modeling apparatus according to the embodiment with respect to the stage.

### DESCRIPTION OF EMBODIMENTS

A preferable embodiment of the present disclosure will be described below in detail with reference to the drawings. The embodiment to be described below does not unduly limit the content of the present disclosure described in the claims. Further, not all of the configurations described below are necessarily essential elements of the present disclosure.

### 1. Three-dimensional Modeling Apparatus

### 1.1. Overall Configuration

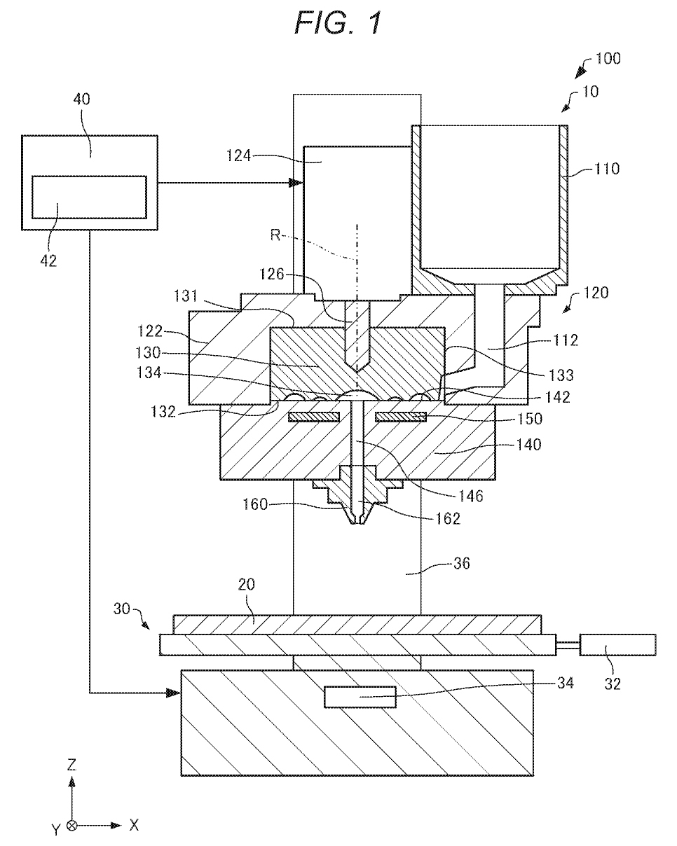

First, the three-dimensional modeling apparatus according to the embodiment is described with reference to the drawings. FIG. 1 is a cross-sectional view schematically illustrating a three-dimensional modeling apparatus 100 according to the embodiment. FIG. 1 illustrates an X axis, a Y axis, and a Z axis as three axes orthogonal to one another. An X-axis direction and a Y-axis direction are, for example, horizontal directions. A Z-axis direction is, for example, a vertical direction.

As illustrated in FIG. 1, the three-dimensional modeling apparatus 100 includes, for example, a discharging unit 10, a stage 20, a position changing unit 30, and a control unit 40.

While causing the discharging unit 10 to discharge a plasticized modeling material toward the stage 20, the three-dimensional modeling apparatus 100 drives the position changing unit 30 to change relative positions of the discharging unit 10 and the stage 20. Accordingly, the three-dimensional modeling apparatus 100 models a three-dimensional object having a desired shape by depositing modeling layers on the stage 20. The three-dimensional modeling apparatus 100 is a three-dimensional modeling apparatus of a fused deposition modeling (FDM) type.

Although not illustrated, a plurality of discharging units 10 may be provided. Two discharging units 10 may be provided. In this case, both of the two discharging units 10 may discharge the modeling material configuring the three-dimensional object or one may discharge the modeling material and the other may discharge a support material that supports the three-dimensional object. The two discharging units 10 may be aligned in the X-axis direction.

As illustrated in FIG. 1, the discharging unit 10 includes, for example, a material supply unit 110, a plasticizing unit 120, and a nozzle 160.

The material supply unit 110 stores a pellet-shaped or powdery material. The material supply unit 110 supplies the material to the plasticizing unit 120. The material supply unit 110 is implemented with, for example, a hopper. The material supplied by the material supply unit 110 is, for example, acrylonitrile butadiene styrene (ABS) resin.

The material supply unit 110 and the plasticizing unit 120 are coupled by a supply path 112 provided below the material supply unit 110. The material charged into the material supply unit 110 is supplied to the plasticizing unit 120 via the supply path 112.

The plasticizing unit 120 includes, for example, a screw case 122, a drive motor 124, a flat screw 130, a barrel 140, and a heater 150. The plasticizing unit 120 plasticizes at least a part of the material in a solid state supplied from the material supply unit 110, generates a paste-shaped modeling material having fluidity, and supplies the modeling material to the nozzle 160.

The term "plasticize" is a concept including melting, and means changing from a solid state to a state having fluidity. Specifically, in a case of a material in which glass transition occurs, the term "plasticize" means setting a temperature of the material to a temperature equal to or higher than a glass transition point. When glass transition does not occur in the material, the term "plasticize" means setting the temperature of the material to a value equal to or higher than a melting point.

The screw case 122 is a housing that houses the flat screw 130. The barrel 140 is provided at a lower surface of the screw case 122. The flat screw 130 is housed in a space surrounded by the screw case 122 and the barrel 140.

The drive motor 124 is provided at an upper surface of the screw case 122. The drive motor 124 is, for example, a servo motor. A shaft 126 of the drive motor 124 is coupled to an upper surface 131 of the flat screw 130. The drive motor 124 is controlled by the control unit 40. The shaft 126 of the drive motor 124 and the upper surface 131 of the flat screw 130 may be coupled via a speed reducer.

The flat screw 130 has a substantially cylindrical shape in which a size in a direction of the rotation axis R is smaller than a size in a direction orthogonal to the direction of the rotation axis R. In the illustrated example, the rotation axis R is parallel to the Z axis. The flat screw 130 is rotated about the rotation axis R by a torque generated by the drive motor 124.

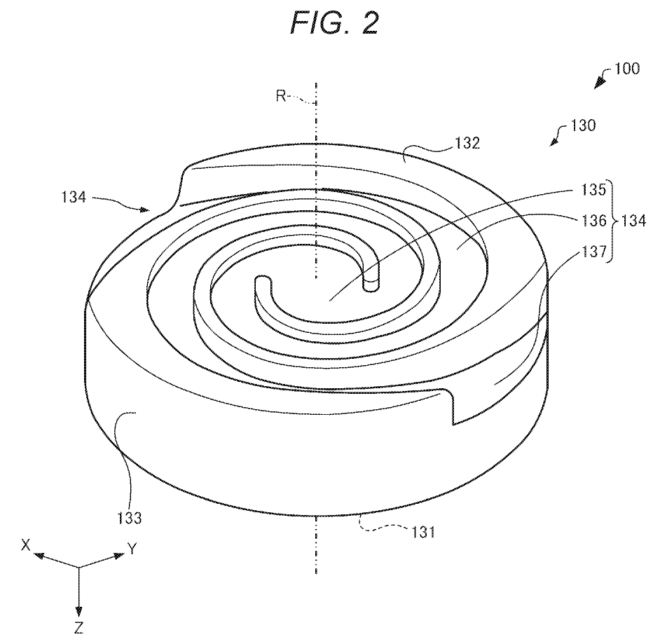

The flat screw 130 includes the upper surface 131, a groove forming surface 132 at an opposite side of the upper surface 131, and a side surface 133 coupling the upper surface 131 and the groove forming surface 132. A first groove 134 is formed at the groove forming surface 132. The side surface 133 is, for example, perpendicular to the groove forming surface 132. Here, FIG. 2 is a perspective view schematically illustrating the flat screw 130. For convenience, FIG. 2 illustrates a state in which an upper-lower positional relationship is reversed from a state illustrated in FIG. 1.

As illustrated in FIG. 2, the first groove 134 is formed at the groove forming surface 132 of the flat screw 130. The first groove 134 includes, for example, a central portion 135, a coupling portion 136, and a material introduction portion 137. The central portion 135 faces a communication hole 146 formed on the barrel 140. The central portion 135 communicates with the communication hole 146. The coupling portion 136 couples the central portion 135 and the material introduction portion 137. In the illustrated example, the coupling portion 136 is provided in a spiral shape from the central portion 135 toward an outer circumference of the groove forming surface 132. The material introduction portion 137 is provided at the outer circumference of the groove forming surface 132. That is, the material introduction portion 137 is provided at the side surface 133 of the flat screw 130. The material supplied from the material supply unit 110 is introduced from the material introduction portion 137 into the first groove 134, passes through the coupling portion 136 and the central portion 135, and is conveyed to the communication hole 146 formed on the barrel 140. For example, two first grooves 134 are formed.

The number of first grooves 134 is not particularly limited. Although not illustrated, three or more first grooves 134 may be formed or only one first groove 134 may be formed. Although not illustrated, the plasticizing unit 120 may include, rather than the flat screw 130, an elongated in-line screw including a spiral groove on a side surface thereof. The plasticizing unit 120 may plasticize a material according to rotation of the in-line screw.

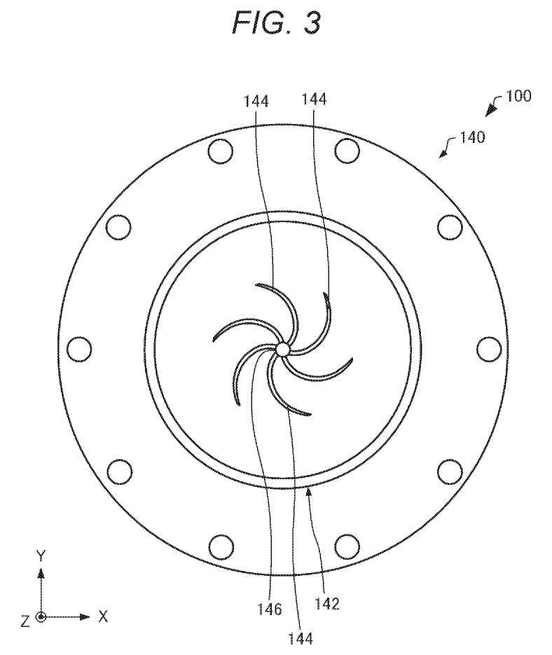

As illustrated in FIG. 1, the barrel 140 is provided below the flat screw 130. The barrel 140 includes a facing surface 142 facing the groove forming surface 132 of the flat screw 130. The communication hole 146 communicating with the first groove 134 is formed in a center of the facing surface 142. Here, FIG. 3 is a plan view schematically illustrating the barrel 140.

As illustrated in FIG. 3, a second groove 144 and the communication hole 146 are formed at the facing surface 142 of the barrel 140. A plurality of second grooves 144 are formed. In the illustrated example, six second grooves 144 are formed. However, the number of second grooves 144 is not particularly limited. The plurality of second grooves 144 are formed around the communication hole 146 as viewed from the Z-axis direction. One end of the second groove 144 is coupled to the communication hole 146 and extends spirally from the communication hole 146 toward an outer circumference of the barrel 140. The second grooves 144 have a function of guiding the plasticized modeling material to the communication hole 146.

Although not illustrated, a shape of the second groove 144 is not particularly limited and may be, for example, a linear shape. The one end of the second groove 144 may not be coupled to the communication hole 146. Further, the second groove 144 may not be formed at the facing surface 142. In consideration of efficiently guiding the plasticized material to the communication hole 146, the second groove 144 is preferably formed at the facing surface 142.

As illustrated in FIG. 1, the heater 150 is provided on the barrel 140. The heater 150 heats the material supplied between the flat screw 130 and the barrel 140. An output of the heater 150 is controlled by the control unit 40. The plasticizing unit 120 heats the material while conveying the material toward the communication hole 146 by the flat screw 130, the barrel 140, and the heater 150 to generate the plasticized modeling material. Then, the plasticizing unit 120 causes the generated modeling material to flow out from the communication hole 146.

Although not illustrated, a shape of the heater 150 may be a ring shape when viewed in the Z-axis direction. The heater 150 may be provided below the barrel 140 instead of on the barrel 140.

The nozzle 160 is provided below the barrel 140. A nozzle flow path 162 is formed in the nozzle 160. The nozzle flow path 162 communicates with the communication hole 146. The modeling material is supplied to the nozzle flow path 162 from the communication hole 146. The nozzle 160 discharges the modeling material supplied to the nozzle flow path 162 toward the stage 20. The three-dimensional modeling apparatus 100 models a three-dimensional object by depositing the modeling material from the nozzle 160 on the stage 20.

The stage 20 is provided below the nozzle 160. In the illustrated example, a shape of the stage 20 is a rectangular parallelepiped. The modeling material discharged from the nozzle 160 is deposited on the stage 20. A material for the stage 20 is, for example, metal such as aluminum.

The position changing unit 30 supports the stage 20. The position changing unit 30 changes relative positions of the discharging unit 10 and the stage 20. The nozzle 160 is moved relative to the stage 20 by the position changing unit 30. In the illustrated example, the position changing unit 30 changes relative positions of the nozzle 160 and the stage 20 in the X-axis direction and the Y-axis direction by moving the stage 20 in the X-axis direction and the Y-axis direction. Further, the position changing unit 30 changes relative positions of the nozzle 160 and the stage 20 in the Z-axis direction by moving the discharging unit 10 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharging unit 10 in the Z-axis direction. The electric actuators 32, 34, and 36 are controlled by the control unit 40.

A configuration of the position changing unit 30 is not particularly limited as long as the position changing unit 30 can change the relative positions of the discharging unit 10 and the stage 20. For example, the position changing unit 30 may move the stage 20 in the Z-axis direction and move the discharging unit 10 in the X-axis direction and the Y-axis direction. The position changing unit 30 may fix the stage 20 and move the discharging unit 10 in the X-axis direction, the Y-axis direction, and the Z-axis direction. The position changing unit 30 may fix the discharging unit 10 and move the stage 20 in the X-axis direction, the Y-axis direction, and the Z-axis direction.

The control unit 40 is implemented with, for example, a computer including a processor, a main storage device, and an input/output interface for inputting and outputting signals from and to an outside. The control unit 40 exerts various functions, for example, by the processor executing a program read into the main storage device. Specifically, the control unit 40 controls the discharging unit 10 and the position changing unit 30. The control unit 40 may include a combination of a plurality of circuits rather than the computer.

The control unit 40 includes, for example, a storage unit 42. The storage unit 42 is implemented with, for example, a random access memory (RAM) and a read only memory (ROM). The storage unit 42 stores, for example, data used in processing of the control unit 40.

### 1.2. Operation

### 1.2.1. Overall Flow

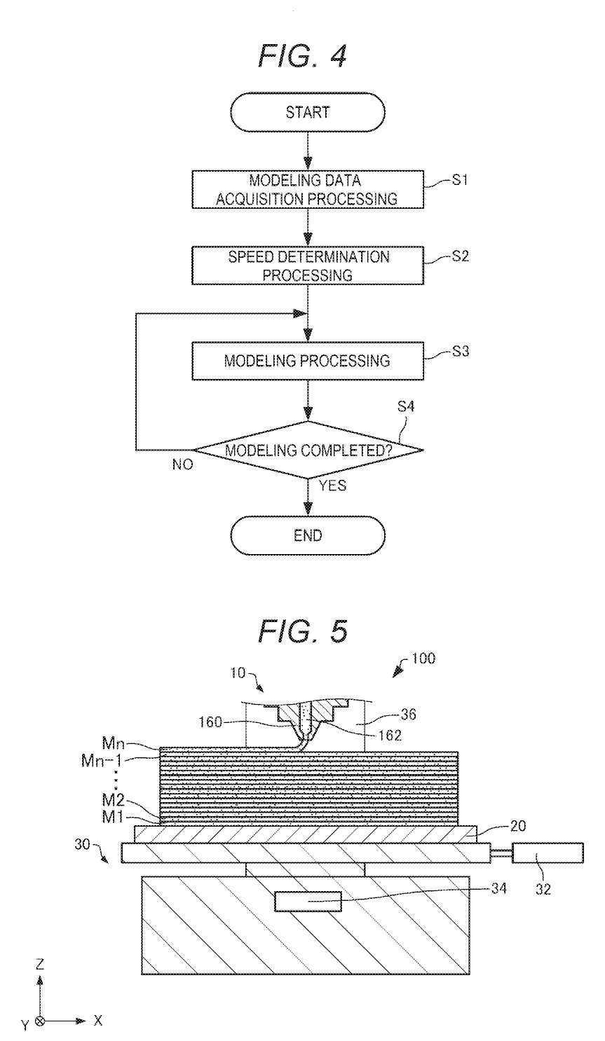

FIG. 4 is a flowchart illustrating an operation of the three-dimensional modeling apparatus 100. Specifically, FIG. 4 is a flowchart illustrating processing of the control unit 40 of the three-dimensional modeling apparatus 100.

For example, a user operates an operation unit (not illustrated) to output, to the control unit 40, a processing start signal for starting processing. The operation unit is implemented with, for example, a mouse, a keyboard, or a touch panel. When receiving the processing start signal, the control unit 40 starts the processing.

First, as illustrated in FIG. 4, in step S1, the control unit 40 performs modeling data acquisition processing of acquiring modeling data for modeling a three-dimensional object.

The modeling data includes, for example, a type of the material stored in the material supply unit 110, path information including a movement path along which the nozzle 160 moves with respect to the stage 20 while discharging the modeling material toward the stage 20, and information on a discharge amount of the modeling material from the nozzle 160 in the movement path.

The modeling data is created by, for example, causing slicer software installed in a computer coupled to the three-dimensional modeling apparatus 100 to read shape data. The shape data is data representing a target shape of a three-dimensional object created using three-dimensional computer aided design (CAD) software, three-dimensional computer graphics (CG) software, or the like. As the shape data, for example, data in a standard triangulated language (STL) format or an additive manufacturing file format (AMF) is used. The slicer software divides the target shape of the three-dimensional object into layers each having a predetermined thickness, and creates modeling data for each layer. The modeling data is represented by a G code, an M code, or the like. The control unit 40 acquires modeling data from a computer coupled to the three-dimensional modeling apparatus 100 or from a recording medium such as a universal serial bus (USB) memory.

Next, in step S2, the control unit 40 performs speed determination processing of determining a speed of the nozzle 160 with respect to the stage 20 based on a bending angle of the movement path in the acquired path information and a distance at which the speed of the nozzle 160 with respect to the stage 20 reaches a predetermined speed. Details of the speed determination processing will be described later.

Next, in step S3, the control unit 40 controls the position changing unit 30 based on the path information in the modeling data and the speed of the nozzle 160 determined in the speed determination processing, and controls the discharging unit 10 to perform modeling processing of discharging the modeling material from the nozzle 160 to deposit the modeling layer while moving the nozzle 160 with respect to the stage 20.

Specifically, the control unit 40 plasticizes the material supplied between the flat screw 130 and the barrel 140 to generate the modeling material, and discharges the modeling material from the nozzle 160 of the discharging unit 10. For example, the control unit 40 continues to generate the modeling material until the modeling processing is ended.

Here, FIG. 5 is a cross-sectional view illustrating the modeling processing performed by the control unit 40 of the three-dimensional modeling apparatus 100.

As illustrated in FIG. 5, while controlling the position changing unit 30 to change the relative positions of the discharging unit 10 and the stage 20, the control unit 40 controls, based on the acquired modeling data, the discharging unit 10 to discharge the plasticized modeling material from the nozzle 160 toward the stage 20.

Specifically, before the modeling processing is started, that is, before formation of a modeling layer M1, which is a first modeling layer, is started, the nozzle 160 is disposed at an initial position in a -X-axis direction relative to an end portion of the stage 20 in the -X-axis direction. When the modeling processing is started, as illustrated in FIG. 5, the control unit 40 controls the position changing unit 30 to, for example, move the nozzle 160 in a +X-axis direction relative to the stage 20. When the nozzle 160 passes over the stage 20, the modeling material is discharged from the nozzle 160. Accordingly, the modeling layer M1 is formed. In FIG. 5, modeling layers up to an n-th modeling layer Mn are illustrated, with n being any natural number. A depositing direction of the plurality of modeling layers is the Z-axis direction.

Next, as illustrated in FIG. 4, in step S4, the control unit 40 performs determination processing of determining whether the formation of all the modeling layers is completed based on the modeling data.

When it is determined that the formation of all the modeling layers has not been completed ("NO" in step S4), the control unit 40 returns the processing to step S2. The control unit 40 repeats steps S3 and S4 until it is determined in step S4 that the formation of all the modeling layers is completed.

Meanwhile, when it is determined that the formation of all the modeling layers is completed ("YES" in step S4), the control unit 40 ends the processing.

### 1.2.2. Speed Determination Processing

### (1) Data Used in Speed Determination Processing

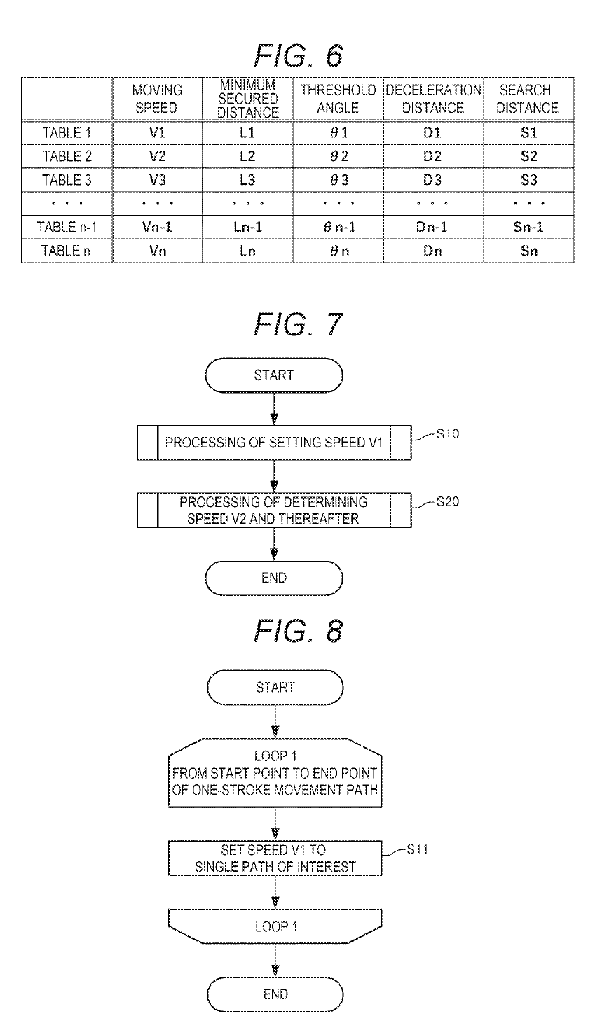

The storage unit 42 of the three-dimensional modeling apparatus 100 stores data used in the speed determination processing. FIG. 6 is a table illustrating data used in the speed determination processing stored in the storage unit 42. FIG. 6 illustrates data of table 1 to table n.

In FIG. 6, a "moving speed" is a moving speed of the nozzle 160 with respect to the stage 20 (hereinafter, also referred to as a "nozzle speed"). V1 is the slowest, and V2, V3, ..., Vn-1, Vn become faster in this order. That is, V2 is faster than V1, V3 is faster than V2, and Vn is faster than Vn-1. When performing processing of increasing the nozzle speed, the control unit 40 performs the processing of increasing the nozzle speed stepwise. For example, when the nozzle speed is increased from the speed V1 to the speed V3, processing of increasing the nozzle speed from the speed V1 to the speed V2 is performed, and then processing of increasing the nozzle speed from the speed V2 to the speed V3 is performed. Similarly, when performing processing of decreasing the nozzle speed, the control unit 40 performs the processing of decreasing the nozzle speed stepwise.

A "minimum secured distance" is a minimum distance to be secured in order for the nozzle 160 to accelerate with respect to the stage 20 and stably discharge the modeling material, and is a distance necessary for the nozzle speed to reach a predetermined value. The minimum secured distance is set according to the nozzle speed.

A "threshold angle" is a threshold of an angle with respect to the nozzle speed in a movement path of the nozzle 160 with respect to the stage 20 (hereinafter, also simply referred to as a "movement path"). The threshold angle is set according to the nozzle speed. For example, in a case where the nozzle speed is Vn, when a bending angle is equal to or larger than θn, the nozzle 160 can be tured while stably discharging the modeling material. Meanwhile, when the bending angle is less than θn, the nozzle 160 cannot be bent while stably discharging the modeling material at the speed Vn. θ1 is the smallest, and θ2, θ3, ..., θn-1, and θn become larger in this order.

A "deceleration distance" is a distance to be secured when it is determined that deceleration is to be performed. The deceleration distance is a distance of a deceleration section. The deceleration distance is set according to the nozzle speed.

A "search distance" is a distance of a section for obtaining a cumulative angle to be used for determination of deceleration. The search distance is set according to the nozzle speed.

### (2) Overall Flow

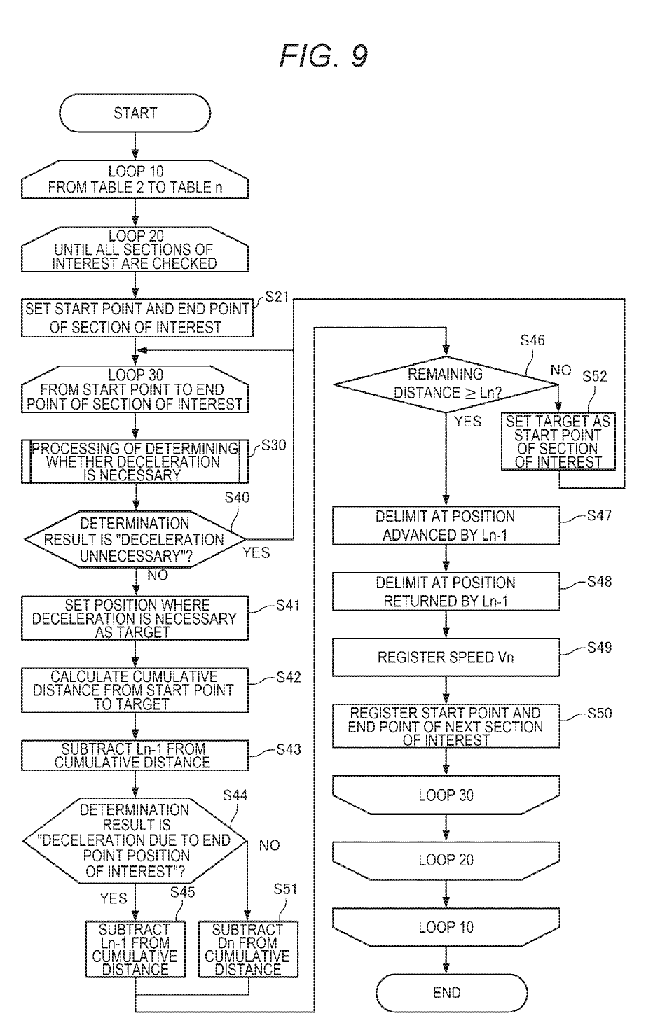

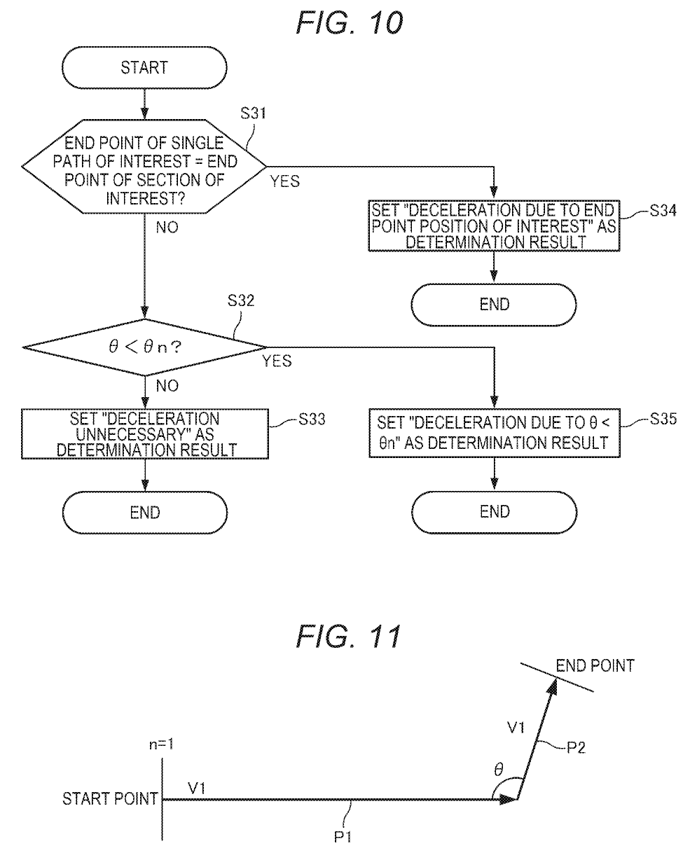

FIGS. 7 to 10 are flowcharts illustrating the speed determination processing of the control unit 40. Specifically, FIG. 7 is a flowchart illustrating the overall flow of the speed determination processing performed by the control unit 40. FIG. 8 is a flowchart illustrating processing of setting the speed V1 by the control unit 40. FIG. 9 is a flowchart illustrating processing of determining the speed V2 and thereafter by the control unit 40. FIG. 10 is a flowchart illustrating processing of determining whether deceleration is necessary by the control unit 40.

After ending the modeling data acquisition processing described above, the control unit 40 performs the speed determination processing. In the speed determination processing, first, as illustrated in FIG. 7, the control unit 40 performs processing of setting the speed V1 in step S10.

Next, in step S20, the control unit 40 performs processing of determining the speed V2 and thereafter. For example, the control unit 40 determines the speed V2, the speed V3, ..., the speed Vn-1, and the speed Vn in this order.

Then, the control unit 40 ends the speed determination processing.

### (3) Setting of Speed V1

Here, FIGS. 11 to 13 are diagrams illustrating a movement path of the nozzle 160 with respect to the stage 20. Hereinafter, a case where arrows illustrated in FIGS. 11 to 13 are the movement paths will be described.

As illustrated in FIG. 11, the movement path is formed in one stroke. The movement path includes a linear single path. In the illustrated example, the movement path includes two single paths P1 and P2. The movement path includes a bending angle θ. The bending angle θis larger than 0° and 180° or less. The bending angle θ may be less than 180°. The larger the bending angle θ, the gentler bending of the movement path. The smaller the bending angle θ, the steeper the bending of the movement path. A position of the bending angle θ is a coupling portion of the single paths P1 and P2.

FIG. 8 is a flowchart illustrating processing of setting the speed V1 by the control unit 40.

As illustrated in FIG. 8, in step S11, the control unit 40 sets the nozzle speed in a single path of interest to the speed V1. Specifically, the control unit 40 sets the speed V1 with the single path of interest as the single path P1. As "loop 1" illustrated in FIG. 8, the control unit 40 repeats the processing of step S11 for all the single paths from a start point to an end point of the movement path. In the example illustrated in FIG. 11, since the movement path includes the single paths P1 and P2, the control unit 40 sets the nozzle speed of the single path P1 to V1 and then sets the nozzle speed of the single path P2 to V1.

Then, the control unit 40 ends the processing of setting the speed V1, and proceeds to processing of determining the speed V2 and thereafter as illustrated in FIG. 7.

### (4) Determination of Speed V2 and Thereafter

FIG. 9 is a flowchart illustrating the processing of determining the speed V2 and thereafter by the control unit 40. Hereinafter, first, processing of determining the speed V2 by the control unit 40 will be described.

As illustrated in FIG. 9, in step S21, the control unit 40 performs processing of setting a start point and an end point of a section of interest. For example, the control unit 40 sets the entire movement path as the section of interest. That is, the control unit 40 sets the start point of the section of interest as a start point of the movement path, and sets the end point of the section of interest as an end point of the movement path. The section of interest includes the bending angle θ.

Next, in step S30, the control unit 40 performs processing of determining whether deceleration of the nozzle speed is necessary. FIG. 10 is a flowchart illustrating processing (step S30) of determining whether the deceleration of the nozzle speed is necessary.

As illustrated in FIG. 10, in step S31, the control unit 40 determines whether a position of an end point of the single path is the same as a position of an end point of the section of interest.

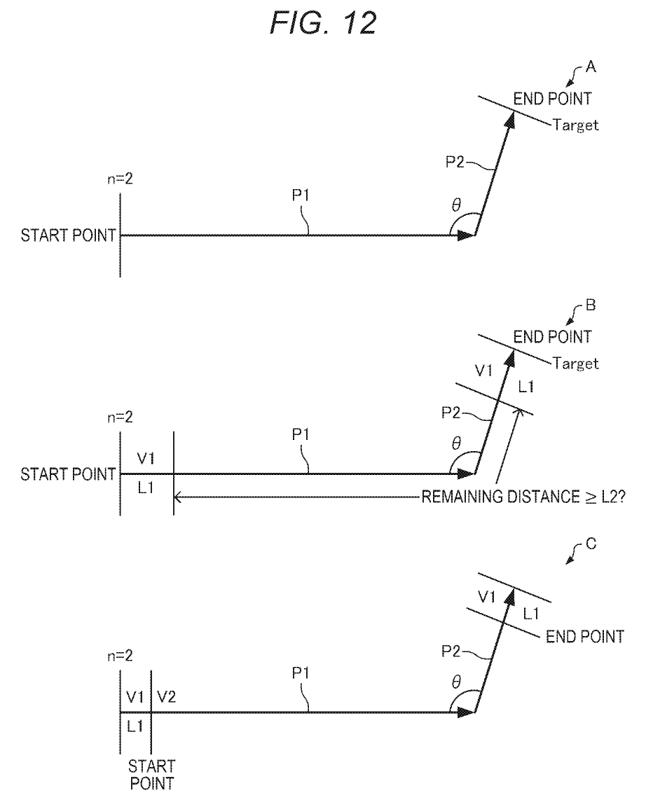

Specifically, the control unit 40 first sets the single path P1 as the single path of interest, and determines whether a position of an end point of the single path P1 is the same as the position of the end point of the section of interest. As illustrated in FIG. 12, the position of the end point of the single path P1 is the position of the bending angle θand is different from the position of the end point of the section of interest. Therefore, the control unit 40 determines that the position of the end point of the single path P1 is not the same as the position of the end point of the section of interest ("NO" in step S31 in FIG. 10).

Next, in step S32, the control unit 40 performs processing of determining whether the bending angle θ in the section of interest is less than the threshold angle θn. Hereinafter, the bending angle θ is larger than θ2 and smaller than θ3. Therefore, when n = 2, the control unit 40 determines that the bending angle θ is equal to or larger than θ2 ("NO" in step S32 in FIG. 10).

Next, in step S33, the control unit 40 sets "deceleration unnecessary" as a determination result of the processing (step S30) of determining whether the deceleration of the nozzle speed is necessary. Then, the control unit 40 ends the processing of step S30.

Next, as illustrated in FIG. 9, in step S40, the control unit 40 performs processing of determining whether "deceleration unnecessary" is set in step S30. As described above, since "deceleration unnecessary" is set for the single path P1 in step S33, the control unit 40 determines that "deceleration unnecessary" is set ("YES" in step S40 in FIG. 9).

As "loop 30" illustrated in FIG. 9, the control unit 40 repeats the processing of step S30 and the processing of step S40 for all the single paths from the start point to the end point of the section of interest. In the example illustrated in A in FIG. 12, since the single path P2 remains, the control unit 40 performs the processing of step S30 on the single path P2.

As illustrated in FIG. 10, in step S31, the control unit 40 determines whether a position of an end point of the single path P2 is the same as the position of the end point of the section of interest. As illustrated in A in FIG. 12, the position of the end point of the single path P2 is the same as the position of the end point of the section of interest. Therefore, the control unit 40 determines that the position of the end point of the single path P2 is the same as the position of the end point of the section of interest ("YES" in step S31 in FIG. 10).

Next, in step S34, the control unit 40 sets "deceleration due to end point position of interest" as a determination result in step S30. Then, the control unit 40 ends the processing of step S30.

Next, as illustrated in FIG. 9, in step S40, the control unit 40 performs processing of determining whether "deceleration unnecessary" is set in step S30. As described above, since "deceleration due to end point position of interest" is set for the single path P2 in step S34, the control unit 40 determines that "deceleration unnecessary" is not set ("NO" in step S40 in FIG. 9).

Next, in step S41, the control unit 40 performs processing of setting a position where deceleration is necessary as a target. As described above, since "deceleration due to end point position of interest" is set in the single path P2, the control unit 40 sets the end point of the single path P2 as the target as illustrated in A in FIG. 12.

Next, as illustrated in FIG. 9, in step S42, the control unit 40 performs processing of obtaining a cumulative distance from the start point of the section of interest to the target. In the example illustrated in A in FIG. 12, since a position of the target is the position of the end point of the section of interest, the cumulative distance is a distance from the start point to the end point of the section of interest.

Next, in step S43, the control unit 40 performs processing of subtracting Ln-1 from the cumulative distance obtained in step S42. When n = 2, the control unit 40 reads a distance L1 from the storage unit 42 and subtracts the distance L1 from the start point of the section of interest as illustrated in B in FIG. 12.

Next, in step S44, the control unit 40 performs processing of determining whether "deceleration due to end point position of interest" is set as the determination result of step S30. As described above, since "deceleration due to end point position of interest" is set in step S34, the control unit 40 determines that "deceleration due to end point position of interest" is set ("YES" in step S44 in FIG. 9).

Next, in step S45, the control unit 40 performs processing of subtracting Ln-1 from the cumulative distance obtained in step S42. When n = 2, the control unit 40 reads the distance L1 from the storage unit 42 and subtracts the distance L1 from the position of the target as illustrated in B in FIG. 12. In the illustrated example, the distance L1 is subtracted from the end point of the section of interest.

Next, in step S46, the control unit 40 performs processing of determining whether a remaining distance as the section of interest is equal to or longer than a distance Ln. When n = 2, the control unit 40 reads a distance L2 from the storage unit 42 and determines whether the remaining distance is equal to or longer than L2. Here, it is assumed that the remaining distance is equal to or longer than L2. Therefore, the control unit 40 determines that the remaining distance is equal to or longer than L2 ("YES" in step S46 in FIG. 9).

Next, in step S47, the control unit 40 performs processing of delimiting the section of interest at a position advanced by the distance Ln-1 from the start point of the section of interest. When n = 2, the control unit 40 delimits the movement path at a position advanced by the distance L1 from the start point of the section of interest.

Next, in step S48, the control unit 40 performs processing of delimiting the section of interest at a position returned by the distance Ln-1 from the end point of the section of interest. When n = 2, the control unit 40 delimits the movement path at a position returned by the distance L1 from the end point of the section of interest.

Next, in step S49, the control unit 40 performs processing of registering the nozzle speed in the section delimited in steps S47 and S48 as the speed V2. For example, the control unit 40 stores the speed V2 in the storage unit 42.

Next, in step S50, as illustrated in C in FIG. 12, the control unit 40 performs processing of registering the position delimited in step S47 as a start point of a next section of interest and registering the position delimited in step S48 as an end point of the next section of interest. For example, the control unit 40 stores the start point and the end point of the section of interest in the storage unit 42.

The control unit 40 repeats the processing of steps S21, S30, and S40 to S52 for all the single paths from the start point to the end point of the section of interest as "loop 30" illustrated in FIG. 9, and then from the table 2 to the table n as "loop 10" until all sections of interest are checked as "loop 20".

Since the processing when n = 2 is completed, the control unit 40 performs the processing when n = 3 on the single path P1. The control unit 40 sets n = 3 for the single path P1 and performs processing of determining whether deceleration is necessary (step S30).

As illustrated in FIG. 10, in step S31, the control unit 40 performs processing of determining whether the position of the end point of the single path P1 is the same as the position of the end point of the section of interest. Since the position of the end point of the single path P1 is the position of the bending angle θ, the control unit 40 determines that the position of the end point of the single path P1 is not the same as the position of the end point of the section of interest ("NO" in step S31 in FIG. 10).

Next, in step S32, the control unit 40 performs processing of determining whether the bending angle θ in the section of interest is less than the threshold angle θn. Since the bending angle θ is larger than θ2 and smaller than θ3, the control unit 40 determines that the bending angle θ is less than θ3 ("YES" in step S32 in FIG. 10).

Next, in step S35, the control unit 40 sets "deceleration due to θ < θn" as the determination result in step S30. Then, the control unit 40 ends the processing of step S30.

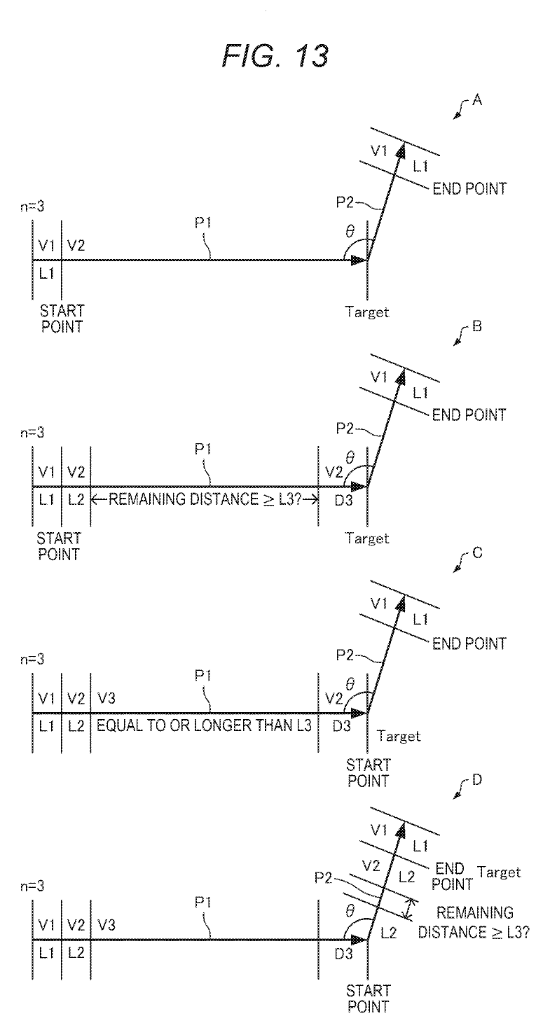

Next, as illustrated in FIG. 9, in step S41, the control unit 40 performs processing of setting a position where deceleration is necessary as a target. As described above, since "deceleration due to θ < θn" is set in step S35, the control unit 40 sets the position of the bending angle θ as a target as illustrated in A in FIG. 13.

Next, in step S42, the control unit 40 performs processing of obtaining a cumulative distance from the start point of the section of interest to the target.

Next, in step S43, the control unit 40 performs processing of subtracting Ln-1 from the cumulative distance obtained in step S42. When n = 3, the control unit 40 reads the distance L2 from the storage unit 42 and subtracts the distance L2 from the start point of the section of interest as illustrated in B in FIG. 13.

Next, in step S44, the control unit 40 performs processing of determining whether "deceleration due to end point position of interest" is set as the determination result of step S30. As described above, since "deceleration due to θ < θn" is set in step S35, the control unit 40 determines that "deceleration due to end point position of interest" is not set ("NO" in step S44 in FIG. 9).

Next, in step S51, the control unit 40 performs processing of subtracting Dn from the cumulative distance obtained in step S42. When n = 3, the control unit 40 reads the distance D3 from the storage unit 42 and subtracts the distance D3 from a position of the target as illustrated in B in FIG. 13.

Next, in step S46, the control unit 40 performs processing of determining whether a remaining distance of the section of interest is equal to or longer than the distance Ln. When n = 3, the control unit 40 reads the distance L3 from the storage unit 42 and determines whether the remaining distance is equal to or longer than L3. Here, it is assumed that the remaining distance is equal to or longer than L3. Therefore, the control unit 40 determines that the remaining distance is equal to or longer than L3 ("YES" in step S46 in FIG. 9).

Next, in step S47, the control unit 40 performs processing of delimiting the movement path at a position advanced by the distance Ln-1 from the start point of the section of interest. When n = 3, the control unit 40 delimits the movement path at a position advanced by the distance L2 from the start point of the section of interest.

Next, in step S48, the control unit 40 performs processing of delimiting the movement path at a position returned by the distance Ln-1 from the end point of the section of interest. When n = 3, the control unit 40 delimits the movement path at a position returned by the distance L2 from the end point of the section of interest.

Next, in step S49, the control unit 40 performs processing of registering the nozzle speed in the section delimited in steps S47 and S48 as the speed V3. For example, the control unit 40 stores the speed V3 in the storage unit 42.

Next, in step S41, the control unit 40 performs processing of registering the position delimited in step S47 as a start point of a next section of interest and registering the position delimited in step S48 as an end point of the next section of interest. For example, the control unit 40 stores the start point and the end point of the section of interest in the storage unit 42.

Next, the control unit 40 repeats the processing of steps S21 to S46 for the single path P1 with n = 4 as in the example described above. Here, it is assumed that the remaining distance is shorter than L4 in step S46. Therefore, the control unit 40 determines that the remaining distance is shorter than L4 ("NO" in step S46 in FIG. 9). The control unit 40 does not perform processing of increasing the nozzle speed from V3 to V4.

Next, in step S52, the control unit 40 performs processing of setting the target as the start point of the next section of interest as illustrated in C in FIG. 13. In the illustrated example, the start point of the section of interest is the start point of the single path P2.

Next, the control unit 40 performs the processing of steps S21 to S46 for the single path P2, as in the example described above. Here, it is assumed that the remaining distance is shorter than L3 in step S46 as illustrated in D in FIG. 13. Therefore, the control unit 40 determines that the remaining distance is shorter than L3 ("NO" in step S46 in FIG. 9).

Next, the control unit 40 performs processing of setting the target as the start point of the next section of interest as illustrated in D in FIG. 13. In the next section of interest, since the nozzle speed is determined to be V1, the control unit 40 determines that the end point of the section of interest is reached in the loop 30. Then, the control unit 40 determines that the processing up to the table n has been performed in all the sections of interest in the loop 20 and the loop 10, and ends the processing of determining the speed V2 and thereafter.

In the method for producing a three-dimensional object according to the embodiment, for example, a three-dimensional object is produced using the processing of the control unit 40 of the three-dimensional modeling apparatus 100 described above.

### 1.3. Functions and Effects

The method for producing a three-dimensional object according to the embodiment includes: a path information acquisition step of acquiring path information including a movement path along which the nozzle 160 moves with respect to the stage 20 while discharging the modeling material toward the stage 20; a speed determination step of determining a speed of the nozzle 160 with respect to the stage 20 based on the bending angle θ of the movement path in the path information and the distance Ln for the speed of the nozzle 160 with respect to the stage 20 to reach a predetermined value; and a modeling step of depositing a modeling layer by discharging the modeling material from the nozzle 160 while moving the nozzle 160 with respect to the stage 20 based on the path information and the determined speed of the nozzle 160.

As described above, in the method for producing a three-dimensional object according to the embodiment, since the nozzle speed is determined based on the bending angle θ and the distance Ln, the nozzle speed can be increased when the nozzle speed can be increased where possible and decreased where necessary. Therefore, both productivity and accuracy of the three-dimensional object can be achieved.

In the method for producing a three-dimensional object according to the embodiment, in the speed determination step, a section of interest is set in the movement path, it is determined whether the bending angle θ in the section of interest is less than the threshold angle θn, and when it is determined that the bending angle θ is less than the threshold angleθn, a deceleration section is set in the section of interest. Therefore, in the method for producing a three-dimensional object according to the embodiment, the nozzle speed can be reduced before the bending angle θ. Accordingly, it is possible to appropriately determine the deceleration for the bending movement path.

In the method for producing a three-dimensional object according to the embodiment, when it is determined that the bending angle θis equal to or larger than the threshold angle θn, in the speed determination step, it is determined whether a remaining distance of a subtraction section between a position obtained by subtracting the distance Ln-1 as a first distance from the start point of the section of interest and a position obtained by subtracting the distance Ln-1 from the end point of the section of interest is equal to or longer than the distance Ln as a second distance longer than the distance Ln-1, and the distance Ln-1 and the distance Ln are set according to the speed of the nozzle 160. Therefore, in the method for producing a three-dimensional object according to the embodiment, it is possible to determine whether the nozzle speed can be increased in the subtraction section.

In the method for producing a three-dimensional object according to the embodiment, when it is determined that the bending angle θ is less than the threshold angle θn, in the speed determination step, it is determined whether a remaining distance of the subtraction section between the position obtained by subtracting the distance Ln-1 from the start point of the section of interest and a position obtained by subtracting the distance Dn of the deceleration section from the position of the bending angle θ is equal to or longer than the distance Ln longer than the distance Ln-1, and the distance Ln-1 and the distance Dn of the deceleration section are set according to the speed of the nozzle 160. Therefore, in the method for producing a three-dimensional object according to the embodiment, it is possible to determine whether the nozzle speed can be increased in the subtraction section.

In the method for producing a three-dimensional object according to the embodiment, in the speed determination step, when it is determined that the remaining distance of the subtraction section is equal to or longer than the distance Ln, the speed of the nozzle 160 in the subtraction section is set to the speed Vn as the second speed greater than the speed Vn-1 as the first speed, and when it is determined that the remaining distance of the subtraction section is less than the distance Ln, the speed of the nozzle 160 in the subtraction section is set to the speed Vn. Therefore, in the method for producing a three-dimensional object, it is possible to determine whether the nozzle speed can be increased according to the remaining distance of the subtraction section.

In the method for producing a three-dimensional object according to the embodiment, in the speed determination step, a next section of interest is set with the position of the bending angle θ as a start point. Therefore, in the method for producing a three-dimensional object, the section of interest can be prevented from being interrupted.

### 2. Modification of Processing of Control Unit

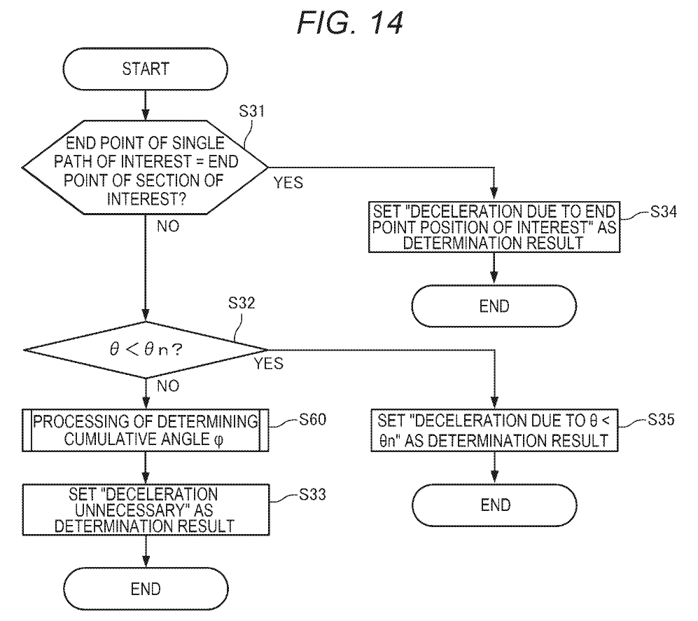

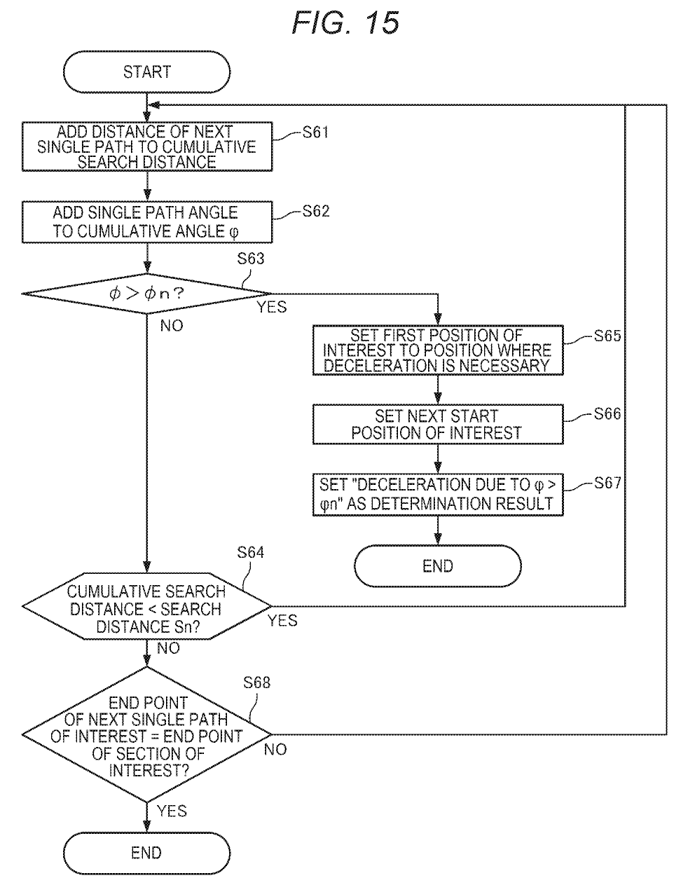

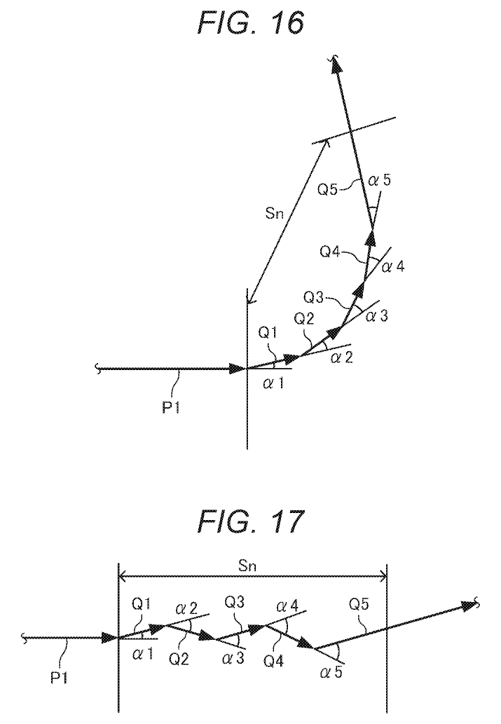

Next, a modification of the processing of the control unit 40 of the three-dimensional modeling apparatus 100 according to the embodiment will be described with reference to the drawings. FIGS. 14 and 15 are flowcharts illustrating processing of the control unit 40. Specifically, FIG. 14 is a flowchart illustrating processing of determining whether deceleration by the control unit 40 is necessary. FIG. 15 is a flowchart illustrating processing of determining the cumulative angle φ by the control unit 40. FIG. 16 is a diagram illustrating a movement path of the nozzle 160 of the three-dimensional modeling apparatus 100 with respect to the stage 20.

Hereinafter, in the modification of the processing of the control unit 40 of the three-dimensional modeling apparatus 100 according to the embodiment, differences from the example of the control unit 40 of the three-dimensional modeling apparatus 100 according to the embodiment described above will be described, and description of similar points will be omitted.

As illustrated in FIG. 14, when it is determined in step S32 that the bending angle θ in the section of interest is equal to or larger than the threshold angleθn ("NO" in step S32 in FIG. 14), the control unit 40 performs processing of determining the cumulative angle φ in step S60.

Here, as illustrated in FIG. 16, the movement path includes the single path P1 and single paths Q1 to Q5. The single path Q1 is coupled to be inclined at a single path angle α1 with respect to the single path P1. The single path Q2 is coupled to be inclined at a single path angle α2 with respect to the single path Q1. The single path Q3 is coupled to be inclined at a single path angle α3 with respect to the single path Q2. The single path Q4 is coupled to be inclined at a single path angle α4 with respect to the single path Q3. The single path Q5 is coupled to be inclined at a single path angle α5 with respect to the single path Q4. The single paths Q1 to Q5 are inclined in the same direction with respect to the previous single path. The single path angle correlates with the bending angle θ. The single path angle is, for example, an angle obtained by subtracting the bending angle θ from 180°. For example, when the bending angle θ is 160°, the single path angle is 20°. The single path angles α1 to α5 are within the search distance Sn in the movement path from a position of an end point of the single path Q1.

In the processing of determining the cumulative angle φ, as illustrated in FIG. 15, the control unit 40 performs processing of adding a distance of the next single path of the single path of interest to a cumulative search distance in step S61. Specifically, the control unit 40 sets a distance of the single path Q1 next to the single path P1, which is the single path of interest, as the cumulative search distance. That is, the cumulative search distance is the distance of the single path Q1.

Next, in step S62, the control unit 40 performs processing of adding an angle of the single path of interest to the cumulative angle φ. Specifically, the control unit 40 adds the single path angle α1 of the single path Q1 to the cumulative angle φ. Accordingly, the cumulative angle φ becomes the angle α1.

Next, in step S63, the control unit 40 performs processing of determining whether the cumulative angle φ is larger than a cumulative threshold angle φn. The cumulative threshold angle φn is set according to the nozzle speed. The cumulative threshold angle φn correlates with the threshold angle θn. The cumulative threshold angle φn is, for example, an angle obtained by subtracting the threshold angle θn from 180°.

Specifically, the control unit 40 determines whether the cumulative angle φ is larger than the cumulative threshold angle φn. Here, the cumulative threshold angle φn is larger than an angle (α1 + α2 + α3) and smaller than an angle (α1 + α2 + α3 + α4). Therefore, the control unit 40 determines that the cumulative angle φ is equal to or less than the cumulative threshold angle φn ("NO" in step S63 in FIG. 15).

Next, in step S64, the control unit 40 determines whether the cumulative search distance is shorter than the search distance Sn. Specifically, the control unit 40 determines whether the cumulative search distance Q1 is less than the search distance Sn. Here, the search distance Sn is longer than a distance (Q1 + Q2 + Q3 + Q4) and shorter than a distance (Q1 + Q2 + Q3 + Q4 + Q5). Therefore, the control unit 40 determines that the cumulative search distance Q1 is shorter than the search distance Sn ("YES" in step S64 in FIG. 15). The control unit 40 returns the processing to step S61.

Next, the control unit 40 sets the cumulative search distance to (Q1 + Q2) and the cumulative angle to (α1 + α2), and repeats the processing of steps S61 to S64.

Next, the control unit 40 sets the cumulative search distance to (Q1 + Q2 + Q3) and the cumulative angle to (α1 + α2 + α3), and repeats the processing of steps S61 to S64.

Next, in step S61, the control unit 40 adds the distance of the single path Q4 to the cumulative search distance to set the cumulative search distance to (Q1 + Q2 + Q3 + Q4).

Next, in step S62, the control unit 40 adds the single path angle α4 of the single path Q4 to the cumulative angle to set the cumulative angle to (α1 + α2 + α3 + α4).

Next, in step S63, the control unit 40 performs processing of determining whether the cumulative angle (α1 + α2 + α3 + α4) is larger than a cumulative threshold angle φn. As described above, the cumulative threshold angle φn is smaller than the angle (α1 + α2 + α3 + α4). Therefore, the control unit 40 determines that the cumulative angle (α1 + α2 + α3 + α4) is larger than the cumulative threshold angle φn ("YES" in step S63 in FIG. 15).

Next, in step S65, the control unit 40 performs processing of setting a first position of interest to a position where deceleration is necessary. In the example illustrated in FIG. 16, the control unit 40 sets a position of a start point of the single path Q1 as the position where deceleration is necessary.

Next, in step S66, the control unit 40 performs processing of setting the next start position of interest. In the example illustrated in FIG. 16, the control unit 40 sets a position of a start point of the single path Q5 as the next start position of interest.

Next, in step S67, the control unit 40 performs processing of setting "deceleration due to φ > φn" as a determination result of the processing of determining whether deceleration is necessary (step S30). Then, the control unit 40 ends the processing of step S30.

Here, when the cumulative threshold angle φn is larger than the angle (α1 + α2 + α3 + α4 + α5), the control unit 40 performs processing of determining whether the cumulative search distance is longer than the search distance Sn, as step S64. As described above, since the distance (Q1 + Q2 + Q3 + Q4 + Q5) is longer than the search distance Sn, the control unit 40 determines that the cumulative search distance (Q1 + Q2 + Q3 + Q4 + Q5) is longer than the search distance Sn ("NO" in step S64 in FIG. 15).

Next, in step S68, the control unit 40 performs processing of determining whether a position of an end point of the next single path of interest is the same as the position of the end point of the section of interest.

When it is determined that the position of the end point of the next single path of interest is not the same as the position of the end point of the section of interest ("NO" in step S68 in FIG. 15), the control unit 40 returns the processing to step S61. Meanwhile, when it is determined that the position of the end point of the next single path of interest is the same as the position of the end point of the section of interest ("YES" in step S68 in FIG. 15), the control unit 40 ends the processing of determining the cumulative angle φ (step S60). Specifically, when the position of the end point of the single path Q5 is the same as the position of the end point of the section of interest, the control unit 40 ends the processing of determining the cumulative angle φ.

Then, as illustrated in FIG. 14, in step S33, the control unit 40 sets "deceleration unnecessary" as the determination result in step S30.

As illustrated in FIG. 17, when the single path Q1 is inclined to one side with respect to the single path P1 and the single path Q2 is inclined to the other side with respect to the single path Q1, the control unit 40 sets a sign of the single path angle α1 to be positive and a sign of the single path angle α2 to be negative, and adds the single path angle of the single path of interest to the cumulative angle φ in step S62. In the illustrated example, the single path Q3 is inclined to one side with respect to the single path Q2, the single path Q4 is inclined to the other side with respect to the single path Q3, and the single path Q5 is inclined to one side with respect to the single path Q4. In this case, the control unit 40 sets the signs of the single path angles α1, α3, and α5 to be positive, sets the signs of the single path angles α2 and α4 to be negative, and calculates a cumulative angle that is a sum of the plurality of single path angles. In step S63, for example, the control unit 40 determines that the cumulative angle (α1 + α2 + α3 + α4 + α5) is equal to or less than the cumulative threshold angle φn ("NO" in step S63 in FIG. 15).

In the method for producing a three-dimensional object according to the embodiment, for example, a three-dimensional object is produced using a modification of the processing of the control unit 40 of the three-dimensional modeling apparatus 100 described above.

In the method for producing a three-dimensional object according to the embodiment, when it is determined that the bending angle θ is equal to or larger than the threshold angle θn, in the speed determination step, in a case where there are a plurality of bending angles θwithin the search distance Sn in the section of interest, when a sum of the single path angles correlated with the bending angles θexceeds the cumulative threshold angle φn, the deceleration section Dn is set in the section of interest. Therefore, in the method for producing a three-dimensional object, the nozzle speed can be reduced before the single path angle.

In the method for producing a three-dimensional object according to the embodiment, when the single path angle α1 as a first single path angle and the single path angle α2 as a second single path angle among the plurality of single path angles are bent in different directions, the sign of the single path angle α1 is positive and the sign of the single path angle α2 is negative, the sum of the plurality of single path angles is calculated. Therefore, in the method for producing a three-dimensional object according to the embodiment, it is possible to prevent the nozzle speed from being reduced before the single path angle α1.

### 3. Modification of Material for Three-Dimensional Modeling Apparatus

Next, a modification of a material for the three-dimensional modeling apparatus 100 according to the embodiment will be described.

In the three-dimensional modeling apparatus 100 described above, the material supplied from the material supply unit 110 to the plasticizing unit 120 is the ABS resin. However, the material supplied from the material supply unit 110 to the plasticizing unit 120 may be a material other than the ABS resin or a material obtained by adding another component to the ABS resin.

Examples of the material supplied from the material supply unit 110 include materials containing various materials such as a thermoplastic material, a metal material, and a ceramic material as main materials. Here, the "main material" means a material mainly forming a shape of the three-dimensional object produced by the three-dimensional modeling apparatus 100 and means a material occupying a content of 50 mass% or more in the three-dimensional object. The material described above includes a material obtained by melting the main material alone and a material obtained by melting a part of components contained together with the main material into a paste form.

Examples of the thermoplastic material include thermoplastic resin. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

In addition to a pigment, a metal, and a ceramic, an additive such as a wax, a flame retardant, an antioxidant, and a heat stabilizer may be mixed into the thermoplastic material. In the plasticizing unit 120, the thermoplastic material is plasticized and converted into a molten state by rotation of the flat screw 130 and heating of the heater 150. A modeling material generated as described above is discharged from the nozzle 160 and deposited on the stage 20 and is thereafter cured by a temperature drop.

In the plasticizing unit 120, for example, a metal material may be used as the main material instead of the above-described thermoplastic material. In this case, it is desirable that a powder material obtained by forming the metal material into powder is mixed with a component that melts when the modeling material is generated, and a mixture is charged into the plasticizing unit 120.

Examples of the metal material include single metal such as magnesium (Mg), iron (Fe), cobalt (Co), chromium (Cr), aluminum (Al), titanium (Ti), copper (Cu), and nickel (Ni) or an alloy containing one or more of these kinds of metal, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include oxide ceramic such as silicon dioxide, titanium dioxide, aluminum oxide, and zirconium oxide and non-oxide ceramic such as aluminum nitride.

A powder material for the metal material or the ceramic material supplied from the material supply unit 110 may be a mixed material obtained by mixing a plurality of kinds of single metal powder, alloy powder, and ceramic material powder. The powder material for the metal material or the ceramic material may be coated with, for example, the thermoplastic resin described above or other thermoplastic resin. In this case, in the plasticizing unit 120, the thermoplastic resin may be melted to exhibit fluidity.

For example, a solvent can be added to the powder material for the metal material or the ceramic material supplied from the material supply unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

In addition, for example, a binder may be added to the powder material for the metal material or the ceramic material supplied from the material supply unit 110. Examples of the binder include acrylic resin, epoxy resin, silicone resin, cellulose-based resin, and other synthetic resin and PLA, PA, PPS, PEEK, and other thermoplastic resin.

The embodiment and modifications described above are merely examples, and the present disclosure is not limited thereto. For example, the embodiment and the modifications can be combined with each other as appropriate.

The present disclosure includes substantially the same configurations as the configurations described in the embodiments, such as configurations having the same functions, methods, and results, or configurations having the same objects and effects. The present disclosure further includes a configuration in which a non-essential portion of the configuration described in the embodiment is replaced with another portion. The present disclosure includes a configuration that has the same action effects as those of the configuration described in the embodiment or a configuration that can achieve the same objects as those achieved by the configuration. The present disclosure includes a configuration with the addition of a known technique to the configuration described in the embodiment.

The following contents can be derived from the embodiment and modifications described above.

According to an aspect, a method for producing a three-dimensional object for modeling the three-dimensional object by depositing a modeling material from a nozzle on a stage, includes: a path information acquisition step of acquiring path information including a movement path along which the nozzle moves with respect to the stage while discharging the modeling material toward the stage; a speed determination step of determining a speed of the nozzle with respect to the stage based on a bending angle of the movement path in the path information and a distance for the speed of the nozzle with respect to the stage to reach a predetermined value; and a modeling step of depositing a modeling layer by discharging the modeling material from the nozzle while moving the nozzle with respect to the stage based on the path information and the determined speed of the nozzle.

According to the method for producing a three-dimensional object, it is possible to achieve both productivity and accuracy of the three-dimensional object.

In the method for producing a three-dimensional object according to the aspect, in the speed determination step, a section of interest may be set in the movement path, a determination may be made as to whether the bending angle in the section of interest is less than a threshold value, and when determining that the bending angle is less than the threshold value, a deceleration section may be set in the section of interest.

According to the method for producing a three-dimensional object, the speed of the nozzle with respect to the stage can be reduced before the bending angle.

In the method for producing a three-dimensional object according to the aspect, when determining that the bending angle is equal to or larger than the threshold value, in the speed determination step, a determination may be made as to whether a distance of a subtraction section between a position obtained by subtracting a first distance from a start point of the section of interest and a position obtained by subtracting the first distance from an end point of the section of interest is equal to or longer than a second distance longer than the first distance, and the first distance and the second distance may be set according to the speed of the nozzle.

According to the method for producing a three-dimensional object, it is possible to determine whether the speed of the nozzle with respect to the stage can be increased in the subtraction section.

In the method for producing a three-dimensional object according to the aspect, when determining that the bending angle is less than the threshold value, in the speed determination step, a determination may be made as to whether a distance of a subtraction section between a position obtained by subtracting a first distance from a start point of the section of interest and a position obtained by subtracting a distance of the deceleration section from a position of the bending angle is equal to or longer than a second distance longer than the first distance, and the first distance and the distance of the deceleration section may be set according to the speed of the nozzle.

According to the method for producing a three-dimensional object, it is possible to determine whether the speed of the nozzle with respect to the stage can be increased in the subtraction section.

In the method for producing a three-dimensional object according to the aspect, in the speed determination step, when determining that the distance of the subtraction section is equal to or longer than the second distance, the speed of the nozzle in the subtraction section may be set to a second speed greater than a first speed, and when determining that the distance of the subtraction section is shorter than the second distance, the speed of the nozzle in the subtraction section may be set to the first speed.

According to the method for producing a three-dimensional object, it is possible to determine whether the speed of the nozzle with respect to the stage can be increased according to the distance of the subtraction section.

In the method for producing a three-dimensional object according to the aspect, in the speed determination step, a next section of interest may be set with the position of the bending angle as a start point.

According to the method for producing a three-dimensional object, the section of interest can be prevented from being interrupted.

In the method for producing a three-dimensional object according to the aspect, when determining that the bending angle is equal to or larger than the threshold value, in the speed determination step, in a case where there are a plurality of bending angles within a predetermined distance in the section of interest, when a sum of single path angles correlated with the respective bending angles exceeds a threshold value, a deceleration section may be set in the section of interest.

According to the method for producing a three-dimensional object, in the method for producing a three-dimensional object, the speed of the nozzle with respect to the stage can be reduced before the single path angle.

In the method for producing a three-dimensional object according to the aspect, when a first single path angle and a second single path angle among the plurality of single path angles are bent in directions different from each other, in the speed determination step, a sign of the first single path angle may be positive and a sign of the second single path angle may be negative, and the sum of the plurality of single path angles may be calculated.

According to the method for producing a three-dimensional object, it is possible to prevent the speed of the nozzle with respect to the stage from being reduced before the first single path angle.

What is claimed is:

1. A method for producing a three-dimensional object for modeling the three-dimensional object by depositing a modeling material from a nozzle on a stage, the method comprising:
a path information acquisition step of acquiring path information including a movement path along which the nozzle moves with respect to the stage while discharging the modeling material toward the stage;
a speed determination step of determining a speed of the nozzle with respect to the stage based on a bending angle of the movement path in the path information and a distance for the speed of the nozzle with respect to the stage to reach a predetermined value; and
a modeling step of depositing a modeling layer by discharging the modeling material from the nozzle while moving the nozzle with respect to the stage based on the path information and the determined speed of the nozzle.

2. The method for producing a three-dimensional object according to claim 1, wherein
in the speed determination step,
a section of interest is set in the movement path,
a determination is made as to whether the bending angle in the section of interest is less than a threshold value, and
when determining that the bending angle is less than the threshold value, a deceleration section is set in the section of interest.

3. The method for producing a three-dimensional object according to claim 2, wherein
when determining that the bending angle is equal to or larger than the threshold value,
in the speed determination step, a determination is made as to whether a distance of a subtraction section between a position obtained by subtracting a first distance from a start point of the section of interest and a position obtained by subtracting the first distance from an end point of the section of interest is equal to or longer than a second distance longer than the first distance, and
the first distance and the second distance are set according to the speed of the nozzle.

4. The method for producing a three-dimensional object according to claim 2, wherein
when determining that the bending angle is less than the threshold value,
in the speed determination step,
a determination is made as to whether a distance of a subtraction section between a position obtained by subtracting a first distance from a start point of the section of interest and a position obtained by subtracting a distance of the deceleration section from a position of the bending angle is equal to or longer than a second distance longer than the first distance, and
the first distance and the distance of the deceleration section are set according to the speed of the nozzle.

5. The method for producing a three-dimensional object according to claim 3, wherein
in the speed determination step,
when determining that the distance of the subtraction section is equal to or longer than the second distance, the speed of the nozzle in the subtraction section is set to a second speed greater than a first speed, and
when determining that the distance of the subtraction section is shorter than the second distance, the speed of the nozzle in the subtraction section is set to the first speed.

6. The method for producing a three-dimensional object according to claim 4, wherein
in the speed determination step, a next section of interest is set with the position of the bending angle as a start point.

7. The method for producing a three-dimensional object according to claim 2, wherein
when determining that the bending angle is equal to or larger than the threshold value,
in the speed determination step, in a case where there are a plurality of bending angles within a predetermined distance in the section of interest, when a sum of single path angles correlated with the respective bending angles exceeds a threshold value, a deceleration section is set in the section of interest.

8. The method for producing a three-dimensional object according to claim 7, wherein
when a first single path angle and a second single path angle among the plurality of single path angles are bent in directions different from each other, in the speed determination step, a sign of the first single path angle is positive and a sign of the second single path angle is negative, and the sum of the plurality of single path angles is calculated.
